(19) United States
(12) Patent Application Publication
(10) Pub. No.: US 2022/0036094 A1
(43) Pub. Date: Feb. 3, 2022

(54) METHOD AND SYSTEM FOR MONITORING SUBJECTS FOR CONDITIONS OR OCCURRENCES OF INTEREST

(71) Applicant: Healthcare Integrated Technologies Inc., Knoxville, TN (US)

(72) Inventors: Kenneth M. GREENWOOD, Davenport, FL (US); Scott Michael BORUFF, Knoxville, TN (US); Jurgen VOLLRATH, Sherwood, OR (US)

(21) Appl. No.: 17/390,819

(22) Filed: Jul. 30, 2021

Related U.S. Application Data
(60) Provisional application No. 63/103,409, filed on Aug. 3, 2020.

(51) Int. Cl. G06K 9/00; G06K 9/62

(52) U.S. Cl. CPC G06K 9/00771; G06K 9/00335; G10L 25/51; G06K 9/6289; G06K 9/6256

(57) ABSTRACT

A method and system for monitoring subjects in facilities, such as hospitals, continuous care retirement communities, and prisons, to identify anomalies in behavior and compliance with rules.

### FIELD OF THE INVENTION

The present invention relates to monitoring of actions and interactions of subjects, especially of the elderly and of people living alone or in prison.

### BACKGROUND OF THE INVENTION

Certain facilities and institutions make it desirable to be able to monitor the activities of human subjects in such facilities. This includes institutions like prisons, for purposes of monitoring the interactions between inmates and between inmates and correctional officers or wardens. It also applies to patients in a hospital or occupants of housing such as senior housing—for example continuous care retirement communities (CCRCs)—in order to monitor their well-being and ensure that their interaction with staff complies with certain rules or agendas or acceptable standards of behavior or care.

### SUMMARY OF THE INVENTION

According to the invention, there is provided a system for monitoring human or robotic subjects in a defined location, comprising at least one image capture device; a memory containing logic defining at least one of: the subject(s) that are permitted in the defined location, and under what circumstances such subject(s) may enter or leave the defined location; a data store for capturing information about one or more of: anomalies, illicit behavior, unsafe conditions, suspicious behavior, abusive behavior, and changes in interactions between subjects (collectively referred to as trigger events), in the defined location based on information provided by the at least one image capture device; a processor configured to process logic contained in the memory; an artificial intelligence (AI) network for identifying trigger events, determining whether a trigger event rises to the level of a flaggable event requiring third-party attention based on type and degree of the event or based on corroboration by data from a second source, and notifying at least one third-party if a flaggable event is identified.

The third-party may be a predefined or dynamically determined person, entity, or secondary system based on the nature of the flaggable event.

The second source may include a second camera or a microphone.

The AI network is preferably configured using training data provided by sensors (such as the image capture device or microphone) which observe the subjects in the defined location. The

AI network may also compare raw data or derived incoming data from the image capture device or microphone to pre-recorded raw or derived image and sound files that comprise flaggable events. The pre-recorded data may also include images and/or characteristics of subjects associated with the defined location(s), as well as their authorizations—implied or explicit—to move in and out of the location.

The at least one image capture device may include one or more of: a radio frequency image capture device, a thermal frequency image capture device, and a video camera.

The trigger event may include one or more of, a subject falling; a subject being immobile in an unexpected area or during an unexpected time of day, or for excessive periods of time, changes in a subject's routine for a particular time of day or over the course of a defined period, changes or odd behavior in the interactions between two or more subjects, attempts by a subject to do things that the subject is not authorized to do, and insufficient performance of required or expected duties or tasks by a subject.

The system may further comprise one or more additional sensors for capturing other forms of data of different modalities about the one or more subjects and their location.

The AI network may be configured to use at least one of timer information, and data from one or more of the additional sensors to corroborate image capture data, or supplement image capture data where image capture data is insufficient or non-existent. The one or more additional sensors may include sensors to capture data about the environmental conditions of the defined location, for purposes of detecting unexpected changes or anomalies in said environment.

Further, according to the invention, there is provided a method of monitoring one or more subjects that are associated with a defined location, comprising capturing information about the one or more subjects, identifying when a monitored subject enters or leaves the defined location, defining the leaving and entering of the defined location as trigger events, comparing the information for a monitored subject to one or more of: information previously captured for said subject, a predefined schedule for said subject, and data from other subjects in similar situations or with similar physical conditions, to detect deviations that constitute a trigger event, time stamping trigger events, identifying those trigger events that rise to the level of a flaggable event, and notifying authorized parties or entities about flaggable events.

The method may further comprise comparing information about each subject to routines from other subjects in similar situations or with similar physical conditions.

The captured information may include image data from one or more image capture devices operating in one or more frequency ranges, including data in raw or processed form.

The processed data may include data that has been transformed by an AI system or subsystem.

The method may further comprise defining opaque zones where image data is not captured, or where image quality is limited or convoluted to protect privacy. Data may be supplemented with alternative sensor information or timing information, to monitor subjects in the opaque zones or monitor their time in the opaque zones.

The comparing of information may include identifying anomalies or unexpected or notable changes in the information, using an artificial intelligence network.

A flaggable event may include one or more of: certain trigger events that have been pre-defined as flaggable events, the same trigger event being repeated more than once, and a trigger event based on a first sensor's data corroborated by at least one other sensor. Pre-defined flaggable events may include one or more of, a subject leaving or entering the location without being expected or authorized to do so, and changes in interactions with other subjects as defined by the nature of the interaction or the identity of the other subject.

Still further, according to the invention there is provide a method of monitoring one or more subjects that are associated with a defined location, comprising capturing image information about the one or more subjects, using one or more image capture devices operating in one or more frequency ranges, wherein the privacy of subjects is protected by defining opaque zones where image data is not captured, or is convoluted, supplementing the image information with non-image sensor information to monitor subjects in the opaque zones, or capturing timing information to monitor their time in the opaque zones, comparing the image information, and at least one of the non-image information, and timing information to previously recorded data defining the routine of the one or more subjects, and defining a flaggable event if an anomaly is detected in the routine of the one or more subjects. The defining of a flaggable event may include the use of an artificial intelligence network.

### BRIEF DESCRIPTION OF THE DRAWINGS

FIG. 1 is a plan view of one embodiment of a system implementation of the present invention;

FIG. 2 is a flow chart defining the logic of one embodiment of an anomaly detection algorithm implemented in an AI system;

FIG. 3 is a flow chart defining the logic of one embodiment of an anomaly detection and corroboration algorithm implemented in an AI system, and

FIG. 4 is a plan view of another embodiment of a system implementation of the present invention.

### DETAILED DESCRIPTION OF THE INVENTION

One aspect of the present invention is to monitor subjects in a certain location to ensure their safety, compliance with specified rules, and in some cases, to deter or monitor for and identify illegal activity.

For instance, one application of the present invention is to monitor the elderly in their suites and when and for how long they leave their suites and the time of day of such departures and returns to define activity routines and subsequently identify departures from such routines.

Also, the present system is applicable to the monitoring of inmates: for purposes of identifying attempts or preparations to escape, or to engage in illegal or impermissible behavior or activities.

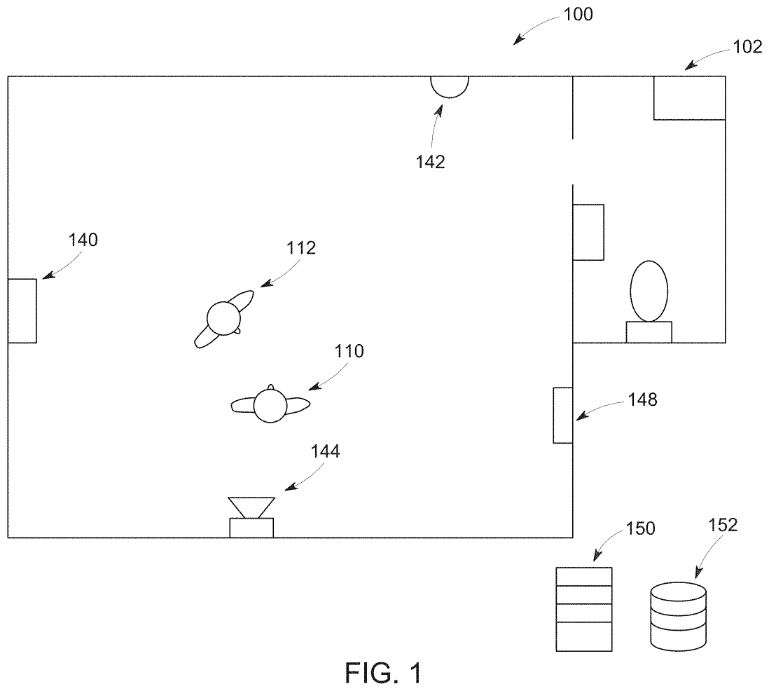

FIG. 1 shows a plan view of a room 100 in a continuous care retirement community (CCRC).

In this embodiment, the subjects who are permitted to see or visit an inhabitant 110 may include a care nurse 112, and family members of the inhabitant (not shown).

Over time, the inhabitant 110 will establish certain activities or routines, e.g., when they go to sleep or times they get up; the regularity and times that they go to the bathroom, the number of times per day and typical times that they may leave their room; how often they receive guests (e.g., the family members), etc.

The interactions with the nurse 112 will also develop certain activities or routines, e.g., times and duration of check-ups on the resident, and delivery of medication or taking of vital signs.

In order to remotely monitor compliance with certain rules, e.g. medication delivery by the nurse 112 to the inhabitant 110, and to identify anomalies in the routines in order to identify potential problems, the present invention includes a monitoring system comprising an image capture device 140, which in this embodiment is a radio-frequency image capture device for purposes of protecting the privacy of the inhabitant 110. In other embodiments the image capture device 140 may be implemented as a video camera, lidar or radar system. In the case of a camera, the pixel density of the image may be limited, or a higher-resolution image may be convoluted to, for example, a point cloud, again for purposes of protecting the privacy of the inhabitant 110.

There may also be areas that are not covered by the image capture device (also referred to herein as opaque zones), either because the regions are hidden from the camera, or are obliterated by design, e.g. certain sections of the bathroom 102, where the inhabitant can expect privacy without being visually monitored.

For these opaque zones, additional sensors may be employed, e.g. a microphone 142 for detecting non-verbal and verbal sounds such as falls or cries for help. The microphone 142, thus supplements the information provided by the image capture device 140. The time spent by the inhabitant 110 in an opaque zone may also be monitored in order to identify excessive times that depart from the inhabitant's routine and could signify a problem.

In this embodiment, the system includes a speaker 144 for engaging the inhabitant 110 in conversation, e.g. to check on the inhabitant 110, whether everything is alright, if they have been in an opaque zone for an excessive period of time.

For purposes of establishing a routine for the inhabitant 110 and any subjects that may interact with the inhabitant 110 from time to time, such as the nurse 112 and visitors, the system includes a processor 150 and memory 152, which in this embodiment are shown as being implemented as a remote server 150 with memory 152 for storing machine readable code and for data storage. The sensor devices (image capture device 140 and microphone 142, as well as speaker 144) communicate by short-range communication (in this case, Bluetooth) with a hub 148, which includes a radio transceiver (not shown), which in this embodiment is implemented as a WiFi connection to the server 150.

It will be appreciated, however, that the system can instead, or in addition, include a local processor and memory for local processing of data.

In the present embodiment, the memory 152 includes machine readable code defining an artificial intelligence (AI) system. The AI system of this embodiment comprises an artificial neural network with inputs comprising data inputs from the image capture device 140 and microphone 142, and outputs defining a routine for the inhabitant 110 and others typically authorized to enter the apartment 100. Once a routine has been established by the AI system based on learning data, the subsequent data received from the image capture device 140 and microphone 142 are used to identify anomalies in the routine and compliance with certain rules and regulations that are included in an algorithm or capture by the AI system as part of the routine.

In the event of an anomaly being detected (e.g. change in routine, excessive time in an opaque zone, etc.,) the AI system, in this embodiment, is configured to validate the anomaly using other sensors, e.g. using the microphone 142 data to corroborate the data from the image capture device 140. It will also engage the inhabitant 110 in conversation using the speaker 144, as discussed above, in order to verify whether there is a problem. Depending on the response from the inhabitant 110 (lack of response or confirmation that there is a problem) the system can elevate a trigger event to an emergency or flagging event, which involves contacting one or more parties or entities stored in a database associated with the inhabitant 110, e.g. CCRC personnel and/or relatives of the inhabitant 110.

In another embodiment, where there may not be a speaker 144, a trigger event (e.g. an anomaly in the routine) may be followed by an attempt at corroboration based on data from one or more other sensors, or may immediately be configured to contact certain parties or entities kept in a database associated with the memory 152 or in a separate memory.

It will be appreciated that in a CCRC environment where inhabitants eat in or frequent a communal area, a similar monitoring system may be implemented in order to monitor the activities of the subjects for anomalies in their behavior, their routine, or their interaction with others.

As indicated above, the present invention involves identification and analysis of anomalies. In one embodiment, the anomaly identification and analysis is implemented in software and involves logic in the form of machine readable code defining an algorithm or implemented in an artificial intelligence (AI) system, which is stored on a local or remote memory (as discussed above), and which defines the logic used by a processor to perform the analysis and make assessments.

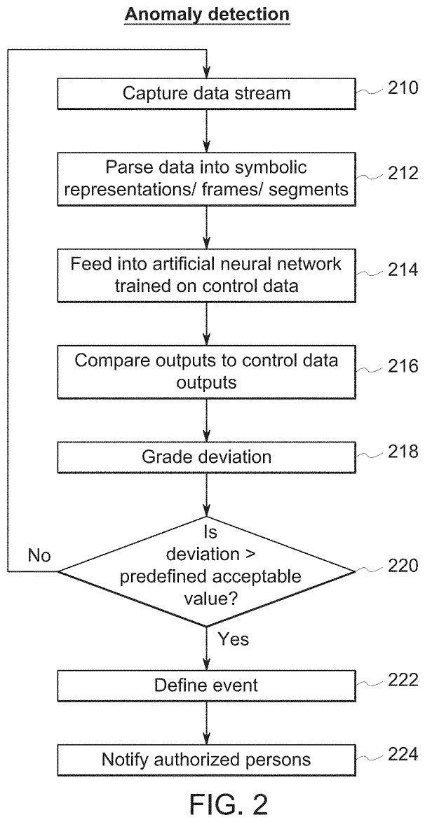

One such embodiment of the logic based on grading the level of the anomaly, is shown in FIG. 2, which defines the analysis based on sensor data that is evaluated by an Artificial Intelligence (AI) system, in this case an artificial neural network. Data from a sensor is captured (step 210) and is parsed into segments (also referred to as symbolic representations or frames) (step 212). The symbolic representations are fed into an artificial neural network (step 214), which has been trained based on control data (e.g. similar previous events involving the same party or parties or similar third-party events). The outputs from the AI are compared to outputs from the control data (step 216) and the degree of deviation is graded in step 218 by assigning a grading number to the degree of deviation. In step 220 a determination is made whether the deviation exceeds a predefined threshold or the anomaly corresponds to a pre-defined flaggable event, in which case the anomaly is registered as a flaggable event (step 222) and one or more authorized persons is notified (step 224)

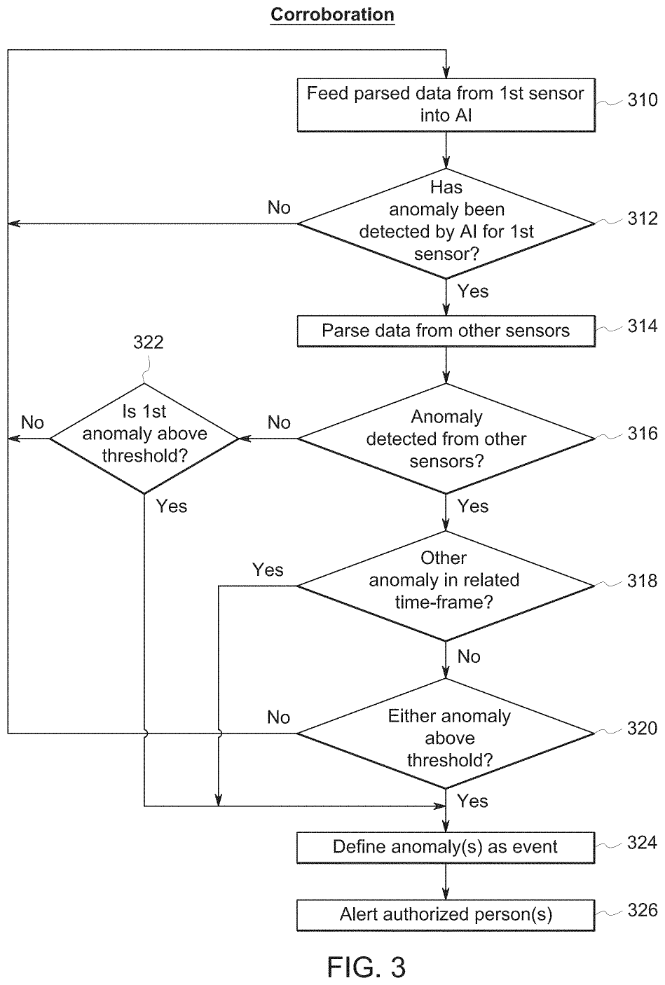

Another embodiment of the logic in making a determination, in this case, based on grading of an anomaly or other trigger event and/or corroboration between sensors is shown in FIG. 3.

Parsed data from a first sensor is fed into an AI system (step 310). Insofar as an anomaly or other trigger event is detected in the data (step 312), this is corroborated against data from at least one other sensor by parsing data from the other sensors that are involved in the particular implementation (step 314). In step 316 a decision is made whether any of the other sensor data shows up an anomaly or other corroborating evidence, in which case it is compared on a time scale whether the second sensor's data is in a related time frame (which could be the same time as the first sensor trigger event or be causally linked to activities flowing from the first sensor trigger event) (step 318). If the second sensor trigger event is above a certain threshold deviation (step 320) or, similarly, even if there is no other corroborating sensor data, if the anomaly or other trigger event from the first sensor data exceeds a threshold deviation (step 322), the anomaly captured from either of such devices triggers a flaggable event (step 324), which alerts one or more authorized persons (step 326).

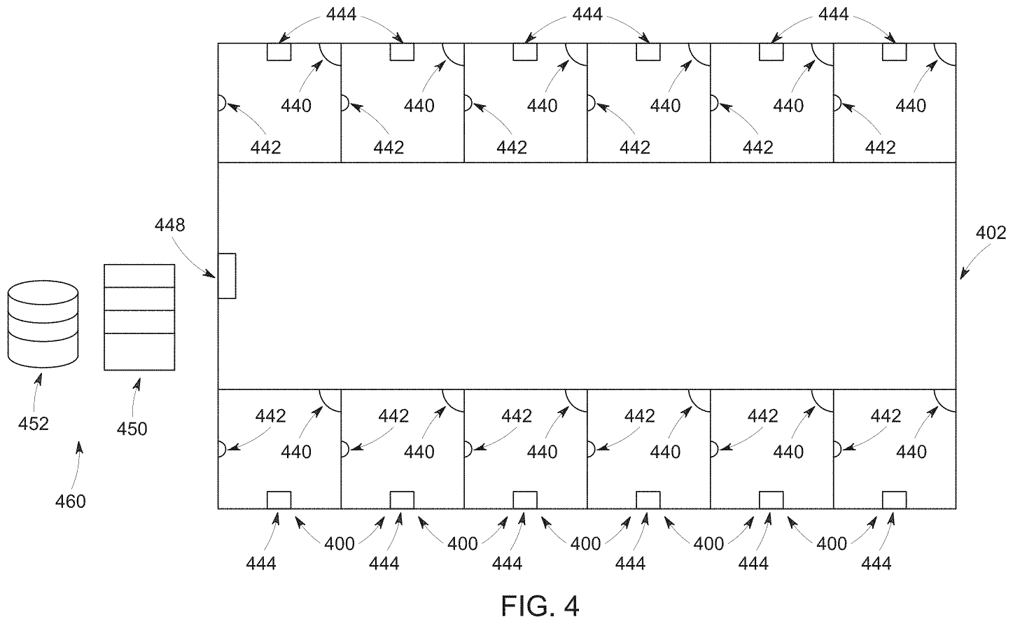

In another embodiment of the present invention, depicted in FIG. 4, the system of the invention is implemented in a prison environment where inmates are restricted either to their cells 400, or a communal area 402, when they are not engaged in recreational activities, eating or other tasks. Each of these areas: cells 400, communal area 402, recreational areas, dining rooms, etc. may be individually monitored for changes in routine by the inmates or correctional officers or wardens, and to monitor the interactions between inmates and between inmates and correctional officers or wardens.

The depiction of FIG. 4 shows only two sets of such areas: the cells 400, and the communal area 402.

Each of these is provided with an image capture device, which in this embodiment comprises a video camera 440 with infra-red capabilities for image capture at night. They also include a microphone 442 and a speaker 444, which in this embodiment is found in each individual area, but could also be limited to the communal area 402 alone.

Similar to the embodiment of FIG. 1, the sensors 440, 442 are connected via a hub 448 to a server 450 with database 452, wherein the server includes machine readable code defining an AI system 460. The AI system 460 captures information from the sensors 440 for each cell 400 and for the communal area 402, to create a routine for each prisoner and warden. The AI system 460 then monitors the behavior of all of the subjects in these regions as well as their interaction to identify anomalies in their behavior, and their interactions, and to detect verbal and non-verbal sounds. The verbal and non-verbal sounds are compared to previously recorded trigger words and sound, or with AI-transformed or AI-interpreted trigger words and sound, associated with arguments, threats, digging activities, and any other unauthorized activities. Thus the AI system compares image data to previously captured image data that defines a routine for each prisoner, correctional officers or group of correctional officers and/or warden, and compares image and sound data to pre-recorded image and sound records either raw or AI-interpreted that are indicative of illicit behavior, such as certain trigger words used by prisoners, or scraping or hammering sounds indicative of an escape attempt, or body postures or movements associated with the exchange of illicit materials or impending violence.

Anomalies or potential unauthorized activities or problems are flagged, and correctional officers or wardens or other response personnel are notified.

In one embodiment, prison personnel are provided with access to the data and flagging events by being presented with a graphical user interface that shows a depiction of the region(s) being monitored. Thus, a warden may be able to see a graphic depiction similar to FIG. 4, in which regions of interest that have been flagged are highlighted (e.g. color coded). They can then select the particular region of interest, e.g. a particular cell 400. In one embodiment the cameras 440 are rotatable and zoomable, allowing prison personnel to manually control the cameras 440 for closer inspection.

The camera footage captured in the database 452 serves also as a compliance record for the activities of the correctional officers and/or wardens in the various zones 400, 402, to deter or detect mistreatment of prisoners, and identify offenders in harmful interactions between prisoners or with prison staff. Thus, the system allows rapid intervention in case of a problem, and continuously monitors the areas for illicit activities or other activities warranting interest or action.

While the present invention has been described with respect to several specific implementations, it will be appreciated that the invention could include additional or different sensors and have different ways of processing and reporting information, without departing from the scope of the invention.

What is claimed is:

1. A system for monitoring human or robotic subjects in a defined location, comprising
at least one image capture device,
a memory containing logic defining at least one of: the subject(s) that are required or permitted in the defined location, and under what circumstances such subject(s) may enter or leave the defined location;
a data store for capturing information about one or more of: anomalies, illicit behavior, unsafe conditions, suspicious behavior, abusive behavior, and changes in interactions between subjects (collectively referred to as trigger events), in the defined location based on information provided by the at least one image capture device,
a processor configured to process logic contained in the memory, and
an artificial intelligence (AI) network for identifying trigger events, determining whether a trigger event rises to the level of a flaggable event that requires third-party attention based on type and degree of the event or based on corroboration by data from a second source, and notifying at least one third-party if a flaggable event is identified.

2. The system of claim 1, wherein the third-party is a predefined or dynamically determined person, entity, or secondary system based on the nature of the flaggable event.

3. The system of claim 1, wherein the second source includes a second camera or a microphone.

4. The system of claim 1, wherein the AI network is configured using training data provided by the at least one image capture device observing the subjects in the defined location.

5. The system of claim 4, wherein the AI network compares raw data or derived incoming data from the at least one image capture device to pre-recorded raw or derived image files indicative of flaggable events.

6. The system of claim 1, wherein the at least one image capture device includes one or more of: a radio frequency image capture device, a thermal frequency image capture device, and a video camera.

7. The system of claim 1, wherein the trigger event includes one or more of, a subject falling, a subject being immobile in an unexpected area or during an unexpected time of day or for excessive periods of time, changes in a subject's routine for a particular time of day or over the course of a defined period, changes or odd behavior in the interactions between two or more subjects, attempts by a subject to do things that the subject is not authorized to do, and insufficient performance of required or expected duties or tasks by a subject.

8. The system of claim 1, further comprising one or more additional sensors for capturing other forms of data of different modalities about the one or more subjects and their location.

9. The system of claim 8, wherein the AI network is configured to use at least one of timer information, and data from one or more of the additional sensors, to corroborate image data or supplement image data where image data is insufficient or non-existent.

10. The system of claim 8, wherein the one or more additional sensors include sensors to capture data about the environmental conditions of the defined location, for purposes of detecting unexpected changes or anomalies in said environment.

11. A method of monitoring one or more subjects that are associated with a defined location, comprising
capturing information about the one or more subjects,
identifying when a monitored subject enters or leaves the defined location,
defining the leaving and entering of the defined location as trigger events,
comparing the information for each subject to one or more of: information previously captured for said subject, a predefined schedule for said subject, and data from other subjects in similar situations or with similar physical conditions, to detect deviations, which constitute a trigger event, time stamping trigger events,
identifying those trigger events that rise to the level of a flaggable event, and notifying authorized parties or entities about flaggable events.

12. The method of claim 11, wherein the captured information includes image data from one or more image capture devices operating in one or more frequency ranges, including data in raw or processed form.

13. The method of claim 12, wherein the processed data includes data that has been transformed by an AI system or subsystem.

14. The method of claim 11, further comprising defining opaque zones where image data is not captured, or where image quality is limited or convoluted to protect privacy.

15. The method of claim 14, wherein image data is supplemented with alternative sensor information or timing information, to monitor subjects in the opaque zones or monitor their time in the opaque zones.

16. The method of claim 11, wherein comparing of information includes identifying anomalies or unexpected or notable changes in the information, using an artificial intelligence network.

17. The method of claim 11, wherein a flaggable event includes one or more of: certain trigger events that have been pre-defined as flaggable events, the same trigger event being repeated more than once, and a trigger event based on a first sensor's data being corroborated by at least one other sensor.

18. The method of claim 17, wherein pre-defined flaggable events include one or more of, a subject leaving or entering the location without being expected or authorized to do so, and changes in interactions with other subjects as defined by the nature of the interaction or the identity of the other subject.

19. A method of monitoring one or more subjects that are associated with a defined location, comprising;=:
capturing image information about the one or more subjects, using one or more image capture devices operating in one or more frequency ranges, wherein the privacy of subjects is protected by defining opaque zones where image data is not captured, or is convoluted,
supplementing the image information with non-image sensor information to monitor subjects in the opaque zones, or capturing timing information to monitor their time in the opaque zones,
comparing the image information, and at least one of the non-image information, and timing information to previously recorded data defining the routine of the one or more subjects, and
defining a flaggable event if an anomaly is detected in the routine of the one or more subjects.

20. The method of claim 19, wherein the defining of a flaggable event includes the use of an artificial intelligence network.
